(19) United States
(12) Patent Application Publication
(10) Pub. No.: US 2006/0189378 A1
(43) Pub. Date: Aug. 24, 2006

(54) Gaming machine having cooperative bonus symbols

(75) Inventor: Dion K. Aoki, Henderson, NV (US)

Correspondence Address: Daniel J. Burnham;JENKENS & GILCHRIST, A PROFESSIONAL CORPORATION, 225 W. Washington, Ste. 2600, Chicago, IL, 60606-3418, US

(73) Assignee: WMS Gaming Inc.

(21) Appl. No.: 11/358,512

(22) Filed: Feb. 21, 2006

Related U.S. Application Data
(60) Provisional application No. 60/655,961, filed on Feb. 23, 2005.

(51) Int. Cl. A63F 13/00

(52) U.S. Cl. 463/20

(57) ABSTRACT

A gaming machine for conducting a wagering game includes a display for displaying a plurality of standard symbols. The plurality of standard symbols indicate a randomly-selected outcome selected from a plurality of possible outcomes. The plurality of outcomes includes at least one winning outcome. The display further displays a bonus quantity symbol and a bonus quality symbol. The gaming machine further includes a controller operative to vary the displayed standard symbols, vary the displayed bonus quantity and bonus quality symbols, and award a bonus award comprising the displayed bonus quantity symbol in cooperation with the displayed bonus quality symbol.

### CROSS REFERENCE TO RELATED APPLICATION

This application claims the benefit of priority of U.S. Provisional Patent Application No. 60/655,961, filed Feb. 23, 2005, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine having a bonus award comprising a plurality of cooperative bonus symbols.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators. The present invention is directed to a gaming machine having a plurality of cooperative bonus symbols.

### SUMMARY OF THE INVENTION

According to one aspect of the present invention, a gaming machine for conducting a wagering game includes a display for displaying a plurality of standard symbols indicating a randomly-selected outcome selected from a plurality of possible outcomes. The plurality of possible outcomes include at least one winning outcome. The display further displays a bonus quantity symbol and a bonus quality symbol. The gaming machine includes a controller operative to vary the displayed standard symbols, bonus quantity symbol and bonus quality symbol, and award a bonus award comprising the displayed bonus quantity symbol in cooperation with the bonus quality symbol.

According to another aspect of the invention, a gaming machine for conducting a wagering game includes a display for displaying a plurality of first reels, a second reel and a third reel. The first reels have a plurality of standard symbols indicating a randomly-selected outcome selected from a plurality of possible outcomes. The plurality of outcomes include at least one winning outcome. The second reel has a plurality of bonus quantity symbols and the third reel has a plurality of bonus quality symbols. The gaming machine further includes a controller operative to spin and stop the first reels to display the standard symbols, and spin and stop the second and third reels to display and award a bonus award. The bonus award comprises one of the bonus quantity symbols displayed on the second reel in cooperation with one of the bonus quality symbols displayed on the third reel.

According to yet another aspect of the invention, a method of conducting a wagering game on a gaming machine comprises receiving a wager through a wager input device and displaying a plurality of first reels, a second reel and a third reel. The first reels have a plurality of standard symbols indicating a randomly-selected outcome selected from a plurality of outcomes, the plurality of outcomes including at least one winning outcome. The second reel has a plurality of bonus quantity symbols and the third reel has a plurality of bonus quality symbols. The method further comprises spinning and stopping the first reels to display the standard symbols and spinning and stopping the second and third reels to display a bonus award. The bonus award comprises at least one of the bonus quantity symbols displayed on the second reel in cooperation with at least one of the bonus quality symbols displayed on the third reel. The method further comprises awarding the bonus award.

According to yet another aspect of the invention, a computer readable storage medium is encoded with instructions for directing a gaming device to perform the above method.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 is a front view of the primary display of a preferred embodiment of the gaming machine;

FIG. 4 is a perspective view of the reels of a preferred embodiment of the gaming machine;

FIG. 5 is a front view of the primary display during an intermediate stage in which the reels are spinning;

FIG. 6 is a front view of the primary display depicting the award of a bonus award;

FIG. 7 is a front view of the primary display depicting the award of another bonus award; and

FIG. 8 is a front view of the primary display depicting the award of yet another bonus award.

### DESCRIPTION OF ILLUSTRATIVE EMBODIMENTS

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

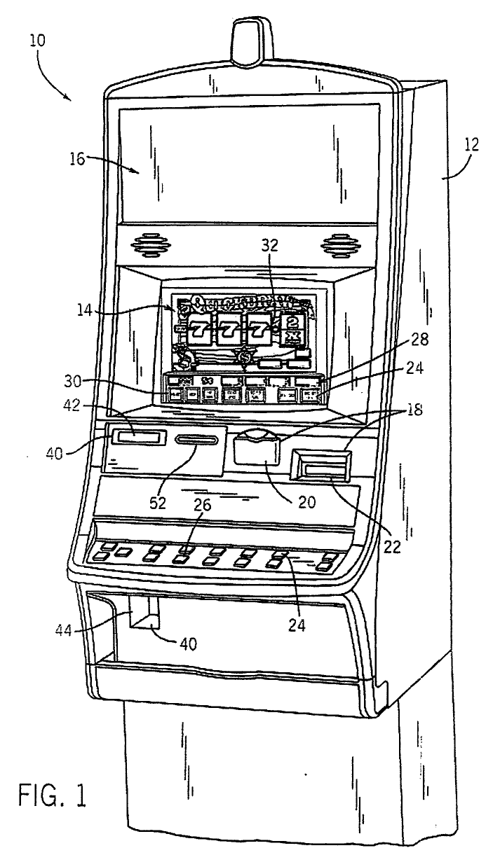

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming Machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

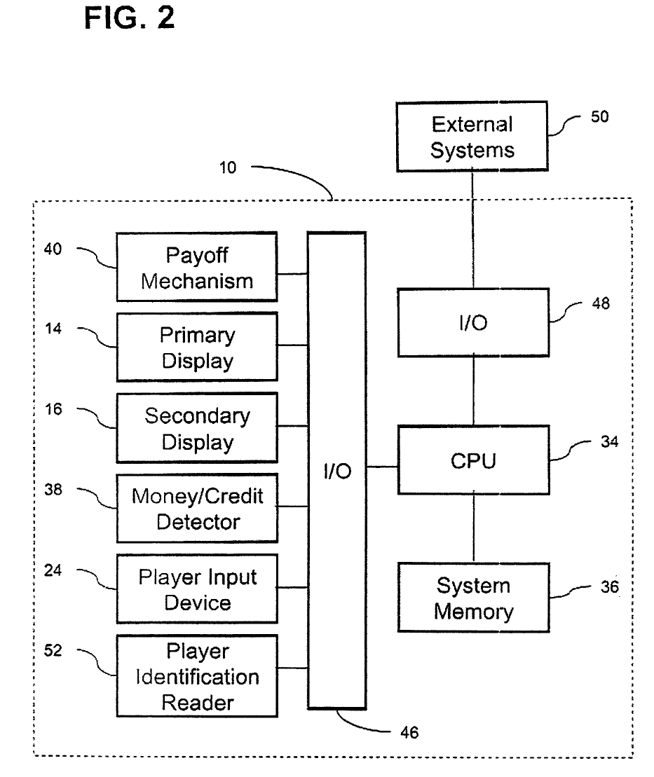

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

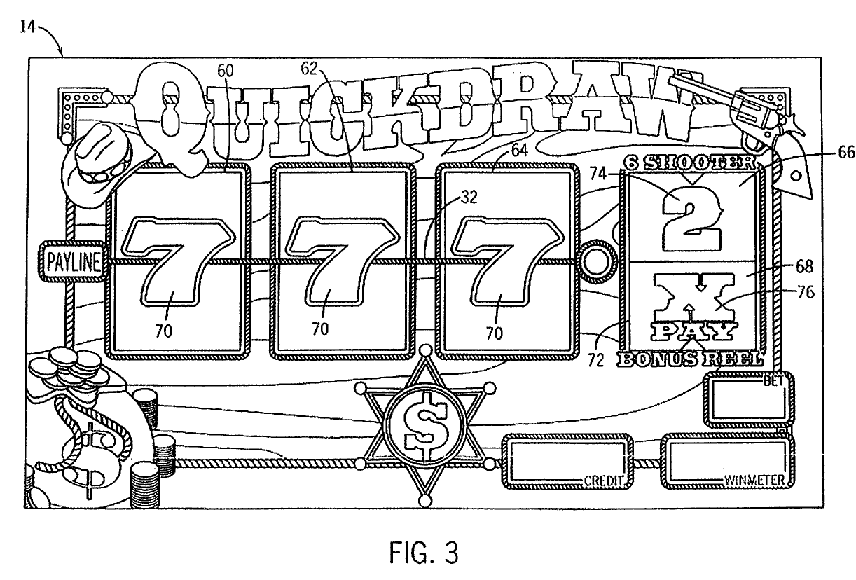

Turning now to FIG. 3, a first preferred embodiment of the gaming machine 10 is depicted wherein the primary display 14 displays a slot game entitled “Quickdraw 7s.”The game comprises three main, or “first” reels 60,62,64 wherein each first reel 60,62,64 has a plurality of standard symbols 70 located thereon. The standard symbols 70 appearing on the first reels 60,62,64 include a “bar” symbol, a “double bar” symbol, a “triple bar” symbol, a “seven” symbol, a “bonus” symbol, and a “wild” symbol, as seen in the FIGS. The display 14 depicts one or more paylines 32 passing through the three first reels 60,62,64 indicating combinations of standard symbols 70. Certain combinations of standard symbols 70 landing on one or more paylines 32 constitute a winning outcome for which a payoff is awarded by the gaming machine 10. Furthermore, at least one of the combinations of standard symbols 70 landing on one or more paylines 32 constitutes a start bonus outcome. In this embodiment, a “bonus” symbol landing anywhere on the payline 32 constitutes a start bonus outcome, entitling the player to play a bonus game.

The display 14 also includes a second reel 66, and a third reel 68, positioned adjacent to the plurality of first reels 60,62,64. In this preferred embodiment, the second reel 66 and third reel 68 work cooperatively, and together comprise a bonus award 72 displayed collectively as a “6 Shooter Bonus Reel.” Thus, the bonus award 72 comprises two reels, the second and third reels 66,68, which appear together in, and are visible through, a single reel window to display a singular outcome. The second and third reels 66,68 are adjacent to one another and preferably are arranged in a side by side fashion. In a preferred embodiment, the second reel 66 has a plurality of bonus quantity symbols 74 located thereon. Similarly, the third reel 68 has a plurality of bonus quality symbols 76 located thereon. In a preferred embodiment, all of the stop positions of the second and third reels 66,68 have bonus quantity and bonus quality symbols 74,76, respectively, located thereon. In other words, the second and third reels 66,68 preferably contain no blank symbols.

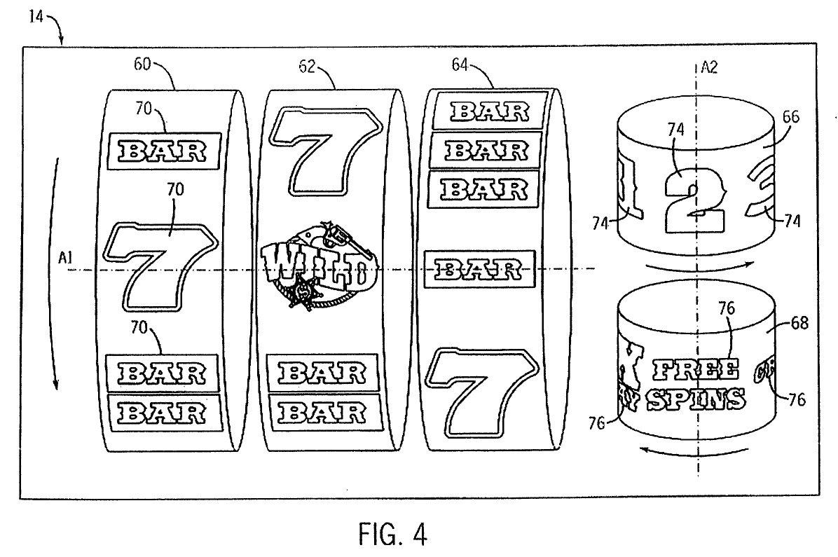

As seen in FIG. 4, although the reels, 60,62,64,66,68 may be simulated reels, in a preferred embodiment, all of the reels 60,62,64,66,68 are electromechanical reels. The first reels 60,62,64 are rotatable, or movable, about a common axis A1, which in a preferred embodiment is horizontal. The second and third reels 66,68 are rotatable about a common axis A2, which in a preferred embodiment is vertical. Thus, in a preferred embodiment, the axes A1,A2 are not parallel. Furthermore, although any of the reels 60,62,64 may be rotated in either direction of rotation, it is preferred that the first reels 60,62,64 in a fashion such that the standard symbols 70 thereon scroll from the top of the display 14, to the bottom. Additionally, it is preferred that the second reel 66 is rotated such that the bonus quantity symbols 74 thereon scroll from the left of the display 14 to the right, while the third reel 68 is rotated such that the bonus quality symbols 76 thereon scroll from the right of the display 14 to the left. In other words, the second and third reels 66,68 rotate in opposite directions about their common axis A2.

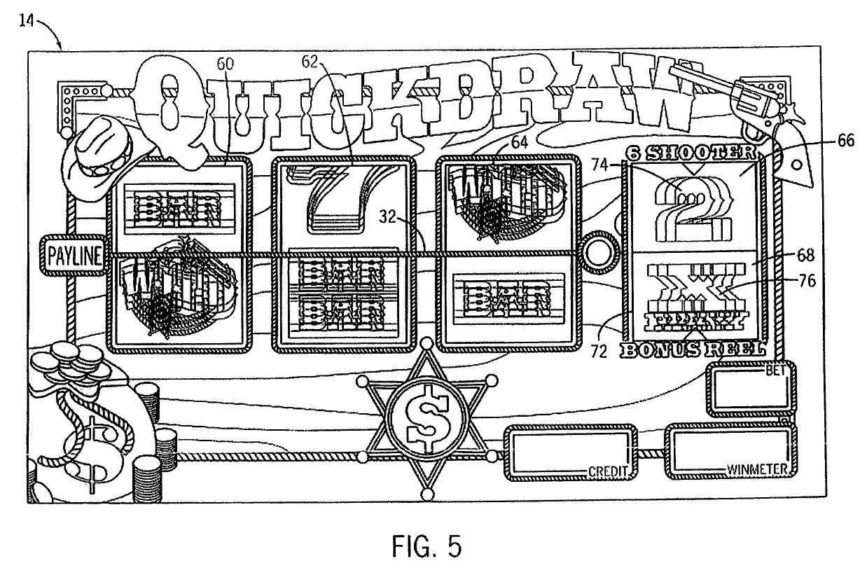

Once a player has placed a wager via the value input device 18, a play of the gaming machine 10 is initiated via the player input device 24. During play of the gaming machine 10, all five reels 60,62,64,66,68 are spun concurrently, as seen in FIG. 5. In a preferred embodiment, the first reels 60,62,64 and the second and third reels 66,68 all commence spinning simultaneously. However, in other configurations, the second and third reel 66,68 may be delayed until the first reels 60,62,64 have spun for a predetermined time.

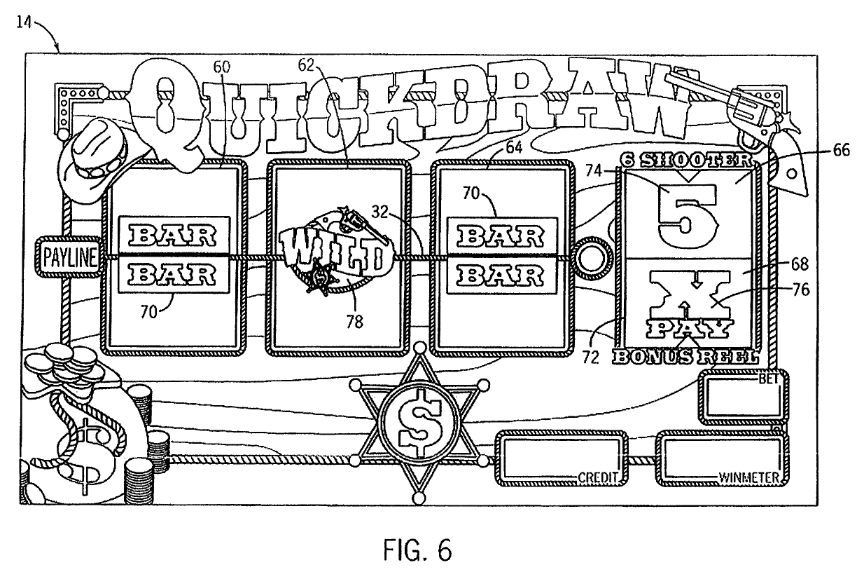

After spinning for a predetermined length of time, the reels 60,62,64,66,68 are stopped, either simultaneously as shown in FIG. 6, or consecutively or in some predetermined order. The first reels 60,62,64 are evaluated for winning outcomes, which, in this preferred embodiment, constitutes a winning combination including a trigger symbol 78. In the “Quickdraw 7s” game depicted in the FIGS., the trigger symbol 78 is a “Wild Shot” symbol, as seen on the center reel 62 in FIG. 6. The trigger symbol 78 serves two purposes. First, the trigger symbol 78 acts as a wild to complete a three symbol pay on the payline 32 of the first reels 60,62,64. In this embodiment of the gaming machine 10, three “double bar” symbols on the payline 32 constitute a winning outcome for which a corresponding payoff is awarded. Thus, in FIG. 6, a three “double bar” winning outcome is achieved because the trigger symbol 78 on the center reel 62 acts as a wild symbol to complete the winning combination. Secondly, the trigger symbol 78 serves to trigger the bonus award 72. Thus, although the bonus award 72 is displayed following every spin of the reels 60,62,64,66,68, the bonus award 72 is only awarded if a winning outcome including the trigger symbol 78 is displayed on the first reels 60,62,64.

When a winning outcome including a trigger symbol 78 occurs on the first three reels 60,62,64 the bonus award 72 is triggered, or awarded. In FIG. 6, the second and third reels 66,68 have come to a stop to display a “5” and an “X Pay” symbol respectively. The bonus award 72 comprises the bonus quantity symbol 74 on the second reel 66 (which in this case is a 5), in cooperation with the bonus quality symbol 76 on the third reel 68 (which in this case is a multiplier symbol “X Pay”). Thus, the bonus award 72 in FIG. 6 is “5x”, or a five times multiplier, which results in the payoff for the three “double bar” winning outcome being awarded and multiplied by five as a bonus award 72.

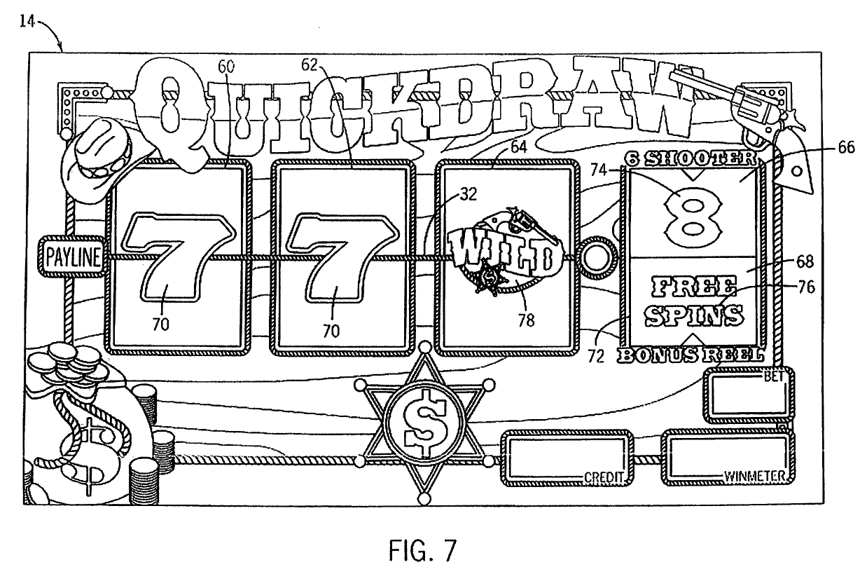

In FIG. 7, a different winning outcome is displayed. The first reels 60,62,64 have come to a stop displaying “7-7-Wild Shot.” Because three “7” symbols is a winning combination, the trigger symbol 78 on the right reel 64 acts as a wild to complete the combination such that the result is a winning outcome. As before, the trigger symbol 78 also serves to award the bonus award 72 indicated by the second and third reels 66,68. On this play of the game, the second and third reels have come to a stop to display an “8” and a “Free Spins” symbol respectively. The bonus award 72 comprises the bonus quantity symbol 74 on the second reel 66 (which in this case is an 8), in cooperation with the bonus quality symbol 76 on the third reel 68 (which in this case is a free spin symbol “Free Spins”). Thus, the bonus award 72 in FIG. 7 is “8 Free Spins” award, which results in the payoff for the three “7” winning outcome being awarded, plus an award of eight free spins of the gaming machine 10 as a bonus award 72.

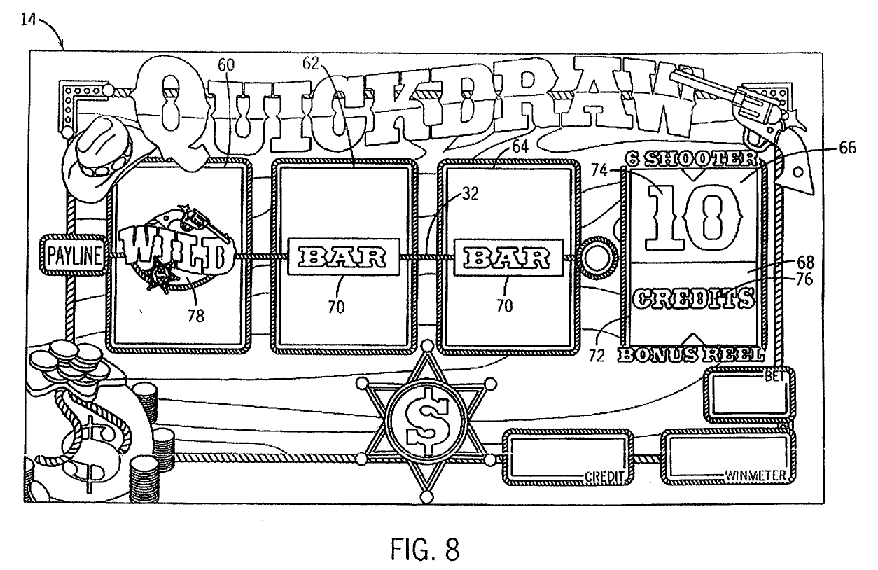

Yet another winning outcome is display in FIG. 8. The first reels 60,62,64 have come to a stop displaying “Wild Shot-Single Bar-Single Bar.” Because three “Single Bar” symbols is a winning combination, the trigger symbol 78 on the left reel 60 acts as a wild to complete the combination such that the result is a winning outcome. As before, the trigger symbol 78 also serves to award the bonus award 72 indicated by the second and third reels 66,68. On this play of the game, the second and third reels have come to a stop to display a “10” and a “Credits” symbol respectively. The bonus award 72 comprises the bonus quantity symbol 74 on the second reel 66 (which in this case is a 10), in cooperation with the bonus quality symbol 76 on the third reel 68 (which in this case is a credit amount symbol “Credits”). Thus, the bonus award 72 in FIG. 7 is “10 Credits” award, which results in the payoff for the three “Single Bar” winning outcome being awarded, plus an award of ten credits as a bonus award 72.

Thus, the bonus award 72 is awarded in response to winning outcomes including the trigger symbol 78. The bonus quantity symbols 74 on the second reel 66 and the bonus quality symbols 76 on the third reel 68 work cooperatively to form the bonus award 72. The cooperative nature of the symbols 74,76 is required in that neither symbol 74,76 acting alone is sufficient to constitute the bonus award 72. Rather, each symbol 74,76 contributes a portion of the character of the bonus award 72. In this embodiment, the bonus quantity symbol 74 contributes the quantity of the bonus award 72, which can vary within a predefined group or range of quantities (e.g. 1, 2, 3, 5, 10, 20, and 50). Similarly, the bonus quality symbol 76 contributes the quality of the bonus award 72, (e.g., multiplier, free spins, credit award) which characterizes the bonus quantity symbol 74 and in turn defines the nature of the bonus award 72. Therefore, the bonus quantity and quality symbols 74,76 cooperate to define the quantity and quality, or nature, of the bonus award 72.

Although in the preferred embodiments described herein the gaming machine 10 comprises only one second reel 66 and one third reel 68, it should be understood that various other configurations are possible. For example, the bonus quantity symbols 74 may be distributed over two or more second reels 66, such that each digit of the award bonus quantity appears on a separate second reel 66 (e.g. three second reels 66 for a three digit bonus quantity). Similarly, the bonus quality symbols 76 may be distributed over two or more third reels 68, such that multiple bonus quality symbols 76 could be awarded in one bonus award 72 (e.g. a bonus award 72 of a “10” bonus quantity symbol 74, accompanied by a “credits” bonus quality symbol 76 on one third reel 68 and a “Free Spins” bonus quality symbol 76 on another third reel 68 would result in a bonus award 72 comprising ten credits plus ten free spins). In such a configuration, the bonus quantity symbols 74 on the two or more second reels 66 would cooperate with the bonus quality symbols 76 on the two or more third reels 68 to comprise the bonus award 72.

In another variation, the second and third reels 66,68 may have cooperative symbols other than bonus quantity and bonus quality symbols 74,76 respectively. The second and third reels 66,68 may have pre-associated pairs of symbols (a second symbols and a third symbol) such that when one of the pre-associated symbols appears on the second reel 66 (the second symbol), and the other of the pre-associated symbols appears on the third reel 68 (the third symbol), the bonus award 72 is triggered. In such a configuration, the two pre-associated symbols displayed simultaneously (one on the second reel 66 and the other on the third reel 68), produce a singular outcome. Preferably, the singular outcome is displayed in a single reel window in which the second and third reels 66,68 are displayed. Alternatively, the pre-associated symbols may comprise portions of a unified symbol such that when the pre-associated symbols are displayed simultaneously on the second and third reels 66,68, a unified symbol image across the reels 66,68 is displayed.

Furthermore, although the first reels 60,62,64 are depicted oriented in a horizontal configuration while the second and third reels 66,68 are oriented in a vertical fashion, multiple configurations are possible. For example, the first reels 60,62,64 may be vertical, while the second and third reels 66,68 may be horizontal. Additionally, all of the reels 60,62,64,66,68 may be oriented in the same direction (horizontal or vertical), about either the same or different axes A1,A2.

The gaming machine 10 of the present invention offers substantial benefits over other gaming machines. The use of the second and third reels 66,68 cooperatively to comprise the bonus award 72 offers the player a unique and exciting gaming experience in that the award 72 is not complete until both portions of the award 72 are determined by the separate reels 66,68. This creates an entertaining feature to the bonus award 72 in that the player derives enjoyment not only from the amount awarded by the bonus award 72, but also from the nature of the award (e.g. a multiplier, free spins, a credit amount) displayed by the bonus quality symbol 76. Furthermore, the spinning of the second and third reels 66,68 along with the first reels 60,62,64 offers the player an exciting opportunity to see possible bonus awards 72 on every play of the gaming machine 10, even though bonus awards 72 are only awarded when a winning outcome includes a trigger symbol 78. This gives the player the thrill of seeing larger bonus awards 72 which the player “could have won,” delivering even more entertainment to the player.

Each of these embodiments and obvious variations thereof is contemplated as falling within the spirit and scope of the claimed invention, which is set forth in the following claims.

What is claimed is:

1. A gaming machine comprising:
a value input device for receiving a wager;
a display for displaying a plurality of standard symbols indicating a randomly-selected outcome selected from a plurality of possible outcomes, the plurality of outcomes including at least one winning outcome, the display further displaying a bonus quantity symbol and a bonus quality symbol; and
a controller operative to (i) vary the displayed standard symbols, (ii) vary the displayed bonus quantity and bonus quality symbols, and (iii) award a bonus award comprising the displayed bonus quantity symbol in cooperation with the displayed bonus quality symbol.

2. The gaming machine of claim 1, wherein the bonus quantity symbol is a numeral.

3. The gaming machine of claim 1, wherein the bonus quality symbol is chosen from the group consisting of a multiplier, a credit amount, and a free spin.

4. The gaming machine of claim 1, further comprising a plurality of first reels, a second reel, and a third reel, wherein the standard symbols are located on the first reels, wherein the bonus quantity symbols are located on the second reel, wherein the bonus quality symbols are located on the third reel, wherein the controller is operative to vary the standard symbols, the bonus quantity symbols and the bonus quality symbols by spinning and stopping the first reels, the second reel and the third reel.

5. The gaming machine of claim 4, wherein the plurality of first reels, the second reel, and the third reel are mechanical or electromechanical reels.

6. The gaming machine of claim 4, wherein the controller is operative to award the bonus award in response to the displayed standard symbols indicating the at least one winning outcome.

7. The gaming machine of claim 6, wherein the winning outcome includes a trigger symbol.

8. The gaming machine of claim 4, wherein a first axis passes through the plurality of first reels, and a second axis passes through the second and third reels, wherein the first and second axes are not parallel.

9. The gaming machine of claim 8, wherein the first axis is horizontal and the second axis is vertical.

10. A gaming machine comprising:
a value input device for receiving a wager;
a display for displaying a plurality of first reels, the first reels having a plurality of standard symbols indicating a randomly-selected outcome selected from a plurality of possible outcomes, the plurality of outcomes including at least one winning outcome, the display further displaying a mechanical second reel and a mechanical third reel, the second and third reels visible through a single reel window, the second reel having a plurality of second symbols, the third reel having a plurality of third symbols; and
a controller operative to (i) spin and stop the first reels to display the standard symbols, (ii) spin and stop the second and third reels to display the second and third symbols, and (iii) award a bonus award based upon the second and third symbols displayed.

11. The gaming machine of claim 10, wherein the second and third symbols comprise a plurality of pre-associated groups, wherein the controller is operative to award the bonus award if the second symbol displayed on the second reel and the third symbol displayed on the third reel are in a pre-associated group.

12. The gaming machine of claim 10, wherein the second symbols are bonus quantity symbols and the third symbols are bonus quality symbols.

13. A method of conducting a wagering game on a gaming machine, the method comprising:
receiving a wager through a value input device;
displaying a plurality of first reels, a second reel, and a third reel, the first reels having a plurality of standard symbols indicating a randomly-selected outcome selected from a plurality of possible outcomes, the plurality of outcomes including at least one winning outcome, the second reel having a plurality of bonus quantity symbols, the third reel having a plurality of bonus quality symbols;
spinning and stopping the first reels to display the standard symbols;
spinning and stopping the second and third reels to display a bonus award, the bonus award comprising at least one of the bonus quantity symbols displayed on the second reel in cooperation with at least one of the bonus quality symbols displayed on the third reel; and
awarding the bonus award.

14. The method of claim 13, wherein the plurality of first reels, the second reel, and the third reel are mechanical or electromechanical reels.

15. The method of claim 13, wherein the step of awarding the bonus award is performed in response to the displayed standard symbols indicating the at least one winning outcome.

16. The method of claim 15, wherein the winning outcome includes a trigger symbol.

17. The method of claim 13, wherein the at least one bonus quality symbol is chosen from the group consisting of a multiplier, a credit amount, and a free spin.

18. The method of claim 13, wherein a first axis passes through the plurality of first reels, and a second axis passes through the second and third reels, wherein the first and second axes are not parallel

19. The method of claim 18, wherein the first axis is horizontal and the second axis is vertical.

20. A computer readable storage medium encoded with instructions for directing a gaming device to perform the method of claim 13.
